(19) United States
(12) Patent Application Publication
(10) Pub. No.: US 2011/0069010 A1
(43) Pub. Date: Mar. 24, 2011

(54) MOBILE TERMINAL AND METHOD OF RECEIVING INFORMATION IN THE SAME

(75) Inventors: Ilbyoung Yi, Seoul (KR); HanBin Lee, Seoul (KR)

(73) Assignee: LG ELECTRONICS INC.

(21) Appl. No.: 12/716,196

(22) Filed: Mar. 2, 2010

(30) Foreign Application Priority Data
Sep. 18, 2009 (KR) 10-2009-0088595

(51) Int. Cl. G06F 3/02

(52) U.S. Cl. 345/169

(57) ABSTRACT

A mobile terminal includes a touch panel receiving a first input, a key input unit at least partially overlapping the touch panel and receiving a second input, and a controller selectively processing a first signal transmitted from the touch panel in response to the first input and a second signal transmitted from the key input unit in response to the second input. The controller processes the first signal as a touch input upon determining absence of the second signal within a predetermined period of time after receiving the first input and processes the second signal as a key input upon determining presence of the second signal within the predetermined period of time after receiving the first input.

### CROSS REFERENCE TO RELATED APPLICATIONS

Pursuant to 35 U.S.C. §119(a), the present application claims the benefit of earlier filing date and right of priority to Korean Application No. 10-2009-0088595 filed on Sep. 18, 2009, the entire contents of which are hereby incorporated by reference herein in their entirety.

### FIELD OF THE INVENTION

The present invention relates to a mobile terminal, and more particularly, to a mobile terminal capable of selectively receiving an input via an input unit including keys overlapping with a touch panel and a method of receiving information in the mobile terminal.

### DISCUSSION OF THE RELATED ART

Mobile terminals with a touch device such as a touch screen or a touch panel have been developed for convenient entry of input. However, such mobile terminals with the touch device may not be as efficient as conventional input devices such as a key input device. Accordingly, development of an input device capable of employing both the advantage of a conventional key input unit including physical keys and the advantage of the touch device is desired.

### SUMMARY OF THE INVENTION

Accordingly, one object of the present invention is to address the above-noted and other drawbacks of the related art. Another object of the present invention is to provide a mobile terminal capable of selectively using an input unit including keys overlapping with a touch panel to receive input via the keys, touch panel or combination of both the keys and touch panel. Still another object of the present invention is to provide a mobile terminal having more efficient input means to users by employing the benefits of both the key input unit and the touch panel.

According to an embodiment of the present invention, a mobile terminal includes a touch panel receiving a first input, a key input unit at least partially overlapping the touch panel and receiving a second input, and a controller selectively processing a first signal transmitted from the touch panel in response to the first input and a second signal transmitted from the key input unit in response to the second input. The controller processes the first signal as a touch input upon determining absence of the second signal within a predetermined period of time after receiving the first input and processes the second signal as a key input upon determining presence of the second signal within the predetermined period of time after receiving the first input.

According to another embodiment of the present invention, a method of receiving an input in a mobile terminal having a user input unit key includes a key input unit and a touch panel includes selectively receiving a first input or a second input via the user input unit, generating a first signal in response to the first input or generating a second signal in response to the second input, processing the first signal as a touch input upon determining absence of the second input within a predetermined period of time after receiving the first input, and processing the second signal as a key input upon determining presence of the second input within the predetermined period of time after receiving the first input. In one aspect of the present invention, the key input unit at least partially overlaps with the touch panel.

According to yet another embodiment of the present invention, a method of receiving information in a mobile terminal includes receiving an input via an input unit of the mobile terminal, wherein the input is for selecting one of a plurality of areas displayed on a display of the mobile terminal for receiving the information, determining distances between a pointer and the plurality of areas displayed on the display in response to the input, selecting one of the plurality of areas which has a shortest distance from the pointer as an area for receiving the information. In one aspect of the present invention, the input unit includes a key input unit at least partially overlapping a touch panel and the input is received via one of a plurality of keys of the key input unit or one of a plurality of touch points on the touch panel.

### BRIEF DESCRIPTION OF THE DRAWINGS

The above and other aspects, features, and advantages of the present invention will become more apparent upon consideration of the following description of preferred embodiments, taken in conjunction with the accompanying drawings.

FIG. 1(a) is a block diagram of a mobile terminal according to an embodiment of the present invention.

FIG. 1(b) is a conceptional diagram for a proximity depth of a proximity sensor.

FIGS. 2(a)-5 illustrate various external appearances of a mobile terminal according to embodiments of the present invention.

FIG. 6 illustrates a structure of an input unit including a touch panel and a key input unit according to an embodiment of the present invention.

FIG. 7 illustrates a touch region for sensing a touch by an external object according to an embodiment of the present invention.

FIG. 8 illustrates a mobile terminal including a toggle key for switching between a touch panel and a key input unit according to an embodiment of the present invention.

FIG. 9 is a flowchart illustrating a method for distinguishing two different signals that can be generated by an input received by a mobile terminal according to an embodiment of the present invention.

FIGS. 10(a)-10(c) illustrate an operation by a mobile terminal according to an embodiment of the present invention to perform the method illustrated in FIG. 9.

FIG. 11 illustrates setting of a touch region in a mobile terminal according to another embodiment of the present invention.

FIG. 12 illustrates an absolute coordinate system used in a mobile terminal according to an embodiment of the present invention.

FIG. 13 illustrates a relative coordinate system used in a mobile terminal according to another embodiment of the present invention.

FIG. 14 illustrates both an absolute coordinate system and a relative coordinate system used in a mobile terminal according to yet another embodiment of the present invention.

FIGS. 15-18 illustrate receiving information by a mobile terminal while accessing a web site according to an embodiment of the present invention.

FIG. 19 illustrates a key input unit used in a mobile terminal according to an embodiment of the present invention.

FIG. 20 illustrates a key input unit used in a mobile terminal according to another embodiment of the present invention.

FIGS. 21(a)-21(c) illustrate a key input unit used in a mobile terminal according to yet another embodiment of the present invention.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

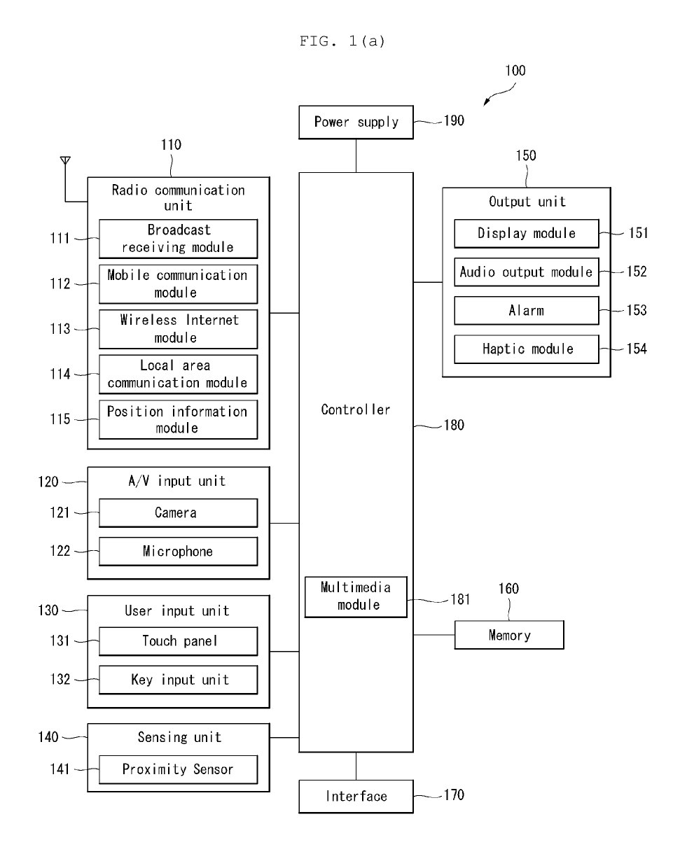

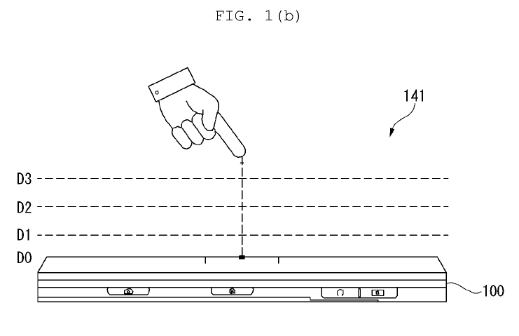

FIG. 1(a) is a block diagram of a mobile terminal 100 according to an embodiment of the present invention. For example, the mobile terminal 100 includes a radio communication unit 110, an audio/video (A/V) input unit 120, a user input unit 130, a sensing unit 140, an output unit 150, a memory 160, an interface 170, a controller 180, and a power supply 190.

The radio communication unit 110 includes at least one module that enables radio communication between the mobile terminal 100 and a radio communication system or between the mobile terminal 100 and a network in which the mobile terminal 100 is located. For example, the radio communication unit 110 includes a broadcast receiving module 111, a mobile communication module 112, a wireless Internet module 113, a local area communication module 114 and a position information module 115.

The broadcast receiving module 111 receives broadcast signals and/or broadcast related information from an external broadcast management server through a broadcast channel. The broadcast channel may include a satellite channel and a terrestrial channel, and the broadcast management server can be a server that generates and transmits broadcast signals and/or broadcast related information or a server that receives previously created broadcast signals and/or broadcast related information and transmits the broadcast signals and/or broadcast related information to a terminal.

Further, the broadcast signals can include not only TV broadcast signals, radio broadcast signals and data broadcast signals, but also signals in the form of combination of a TV broadcast signal and a radio broadcast signal. In addition, the broadcast related information can be information on a broadcast channel, a broadcast program or a broadcast service provider. Moreover, the broadcast related information can be provided even through a mobile communication network such that the broadcast related information can be received by the mobile communication module 112.

The broadcast related information may exist in various forms. For example, the broadcast related information can exist in the form of an electronic program guide (EPG) of the digital multimedia broadcasting (DMB) system or in the form of an electronic service guide (ESG) of the digital video broadcast-handheld (DVB-H) system.

In addition, the broadcast receiving module 111 receives broadcast signals using various broadcasting systems. Particularly, the broadcast receiving module 111 can receive digital broadcast signals using digital broadcasting systems such as the digital multimedia broadcasting-terrestrial (DMB-T) system, the digital multimedia broadcasting-satellite (DMB-S) system, the media forward link only (MediaFLO) system, the DVB-H and integrated services digital broadcast-terrestrial (ISDB-T) systems. The broadcast receiving module 111 can also be constructed to be suited to broadcasting systems providing broadcast signals other than the above-described digital broadcasting systems.

Further, the broadcast signals and/or broadcast related information received through the broadcast receiving module 111 can be stored in the memory 160. The mobile communication module 112 transmits/receives a radio signal to/from at least one of a base station, an external terminal and a server on a mobile communication network. The radio signal can include a voice call signal, a video telephony call signal or data in various forms according to transmission and reception of text/multimedia messages.

The wireless Internet module 113 corresponds to a module for wireless Internet access and can be included in the mobile terminal 100 or externally attached to the mobile terminal 100. A wireless LAN (WLAN) (Wi-Fi), wireless broadband (Wibro), world interoperability for microwave access (Wimax), or high speed downlink packet access (HSDPA) can be used as a wireless Internet technique.

The local area communication module 114 corresponds to a module for local area communication. For example, BLUETOOTH®, radio frequency identification (RFID), infrared data association (IrDA), ultra wideband (UWB) or ZigBee® can be used as a local area communication technique.

The position information module 115 confirms or obtains the position of the mobile terminal 100. In more detail, a global positioning system (GPS) module is a representative example of the position information module 115. In addition, the GPS module 115 can calculate information on distances between one point or object and at least three satellites and information on the time when the distance information is measured and apply trigonometry to the obtained distance information to obtain three-dimensional position information on the point or object according to the latitude, longitude and altitude at a predetermined time.

Furthermore, a method of calculating position and time information using three satellites and correcting the calculated position and time information using another satellite can also used. In addition, the GPS module 115 continuously calculates the current position in real time and calculates velocity information using the position information.

Referring to FIG. 1(a), the A/V input unit 120 is used to input an audio signal or a video signal and includes a camera 121 and a microphone 122. The camera 121 processes image frames of still images or moving images obtained by an image sensor in a video telephony mode or a photographing mode. Further, the processed image frames can be displayed on a display module 151.

The image frames processed by the camera 121 can be stored in the memory 160 or transmitted to an external device through the radio communication unit 110. The mobile terminal 100 can also include at least two cameras 121. The microphone 122 receives an external audio signal in a call mode, a recording mode or a speed recognition mode and processes the received audio signal into electric audio data.

The audio data can then be converted into a form that can be transmitted to a mobile communication base station through the mobile communication module 112 and output in the call mode. Further, the microphone 122 can employ various noise removal algorithms for removing noise generated when the external audio signal is received.

In addition, the user input unit 130 receives input data for controlling the operation of the mobile terminal 100 from a user. The user input unit 130 may include a keypad, a dome switch, a touch pad (constant voltage/capacitance), jog wheel, or jog switch.

According to an embodiment of the present invention, the user input unit 130 includes a touch panel 131 and a key input unit 132. The touch panel 131 performs the same function as that of a touch sensor or a touch screen which will be explained later. The touch panel 131 generates a touch signal in response to a touch input and transmits the touch signal to the controller 180.

For example, the key input unit 132 includes a plurality of dome keys. Each of the plurality of dome keys generates a different key signal and transmits the key signal to the controller 180. The key input unit 132 may also include a key PCB, a dome sheet and a key pad.

The sensing unit 140 senses the current state of the mobile terminal 100, such as an open/close state of the mobile terminal 100, the position of the mobile terminal 100, whether a user touches the mobile terminal 100, the direction of the mobile terminal 100 and the acceleration/deceleration of the mobile terminal 100, and generates a sensing signal for controlling the operation of the mobile terminal 100. For example, the sensing unit 140 can sense whether a slide phone is opened or closed when the mobile terminal 100 is a slide phone. Furthermore, the sensing unit 140 can sense whether the power supply 190 supplies power and whether the interface 170 is connected to an external device. The sensing unit 140 can also include a proximity sensor 141.

Referring to FIG. 1(a), the proximity sensor 141 of the sensing unit 140 may be located in an internal region of the mobile terminal 100, surrounded by the touch screen, or near the touch screen. The proximity sensor 141 senses an object approaching a predetermined sensing face or an object located near the proximity sensor 141 using an electromagnetic force or infrared rays without having mechanical contact. Further, the proximity sensor 141 may have a lifetime longer than that of a contact sensor, and thus, has a wide application in the mobile terminal 100.

Furthermore, the proximity sensor 141 includes a transmission type photo-electric sensor, a direct reflection type photo-electric sensor, a mirror reflection type photo-electric sensor, a high-frequency oscillating proximity sensor, a capacitive proximity sensor, a magnetic proximity sensor, or an infrared proximity sensor. Further, a capacitive touch screen is constructed such that proximity of a pointer is detected through a variation in an electric field according to the proximity of the pointer. In this instance, the touch screen or touch sensor can be classified as a proximity sensor 141.

For convenience of explanation, the action of the pointer approaching the touch screen without actually touching the touch screen is referred to as “proximity touch” and an action of bringing the pointer into contact with the touch screen is referred to as “contact touch” in the following description. In addition, the proximity touch point of the pointer on the touch screen corresponds to a point of the touch screen to which the pointer makes contact.

Further, the proximity sensor 141 senses the proximity touch and a proximity touch pattern, such as a proximity touch distance, a proximity touch direction, a proximity touch velocity, a proximity touch time, a proximity touch position, or a proximity touch moving state. Information corresponding to the sensed proximity touch action and proximity touch pattern can then be displayed on the touch screen.

In addition, the output unit 150 generates visual, auditory or tactile output and includes, for example, the display module 151, an audio output module 152, an alarm 153 and a haptic module 154. The display module 151 displays information processed by the mobile terminal 100.

For example, the display module 151 displays a user interface (UI) or graphic user interface (GUI) related to a telephone call when the mobile terminal 100 is in the call mode. The display module 151 also displays a captured or/and received image, UI or GUI when the mobile terminal 100 is in the video telephony mode or the photographing mode.

In addition, the display unit 151 may include at least a liquid crystal display, a thin film transistor liquid crystal display, an organic light-emitting diode display, a flexible display or a three-dimensional display. Further, some of these displays can be of a transparent type or a light transmission type. That is, the display module 151 can include a transparent display.

In more detail, the transparent display includes a transparent liquid crystal display. Further, the rear structure of the display module 151 can also be of the light transmission type. Accordingly, a user can see an object located behind the body of the mobile terminal 100 through the transparent area of the body of the mobile terminal 100, which is occupied by the display module 151.

The mobile terminal 100 may have at least two display modules 151. For example, the mobile terminal 100 may include a plurality of displays that are arranged on a single face at a predetermined distance or integrated displays. The plurality of displays can also be arranged on different sides.

In addition, when the display module 151 and a touch sensor that senses touch form a layered structure or a touch screen, the display module 151 can be used as an input device as well as an output device. The touch sensor can be in the form of a touch film, a touch sheet and a touch pad, for example.

Further, the touch sensor can be constructed to convert a variation in pressure applied to a specific portion of the display module 151 or a variation in capacitance generated at a specific portion of the display module 151 into an electric input signal. The touch sensor can also be constructed to sense pressure of touch as well as the position and area of the touch.

When the user applies touch input to the touch sensor, a signal corresponding to the touch input is transmitted to a touch controller (not shown). The touch controller then processes the signal and transmits data corresponding to the processed signal to the controller 180. Accordingly, the controller 180 can detect a touched portion of the display module 151.

The audio output module 152 can output audio data received from the radio communication unit 110 or stored in the memory 160 in a call signal receiving mode, a telephone call mode or a recording mode, a speech recognition mode and a broadcasting receiving mode. Further, the audio output module 152 outputs audio signals related to functions performed in the mobile terminal 100, such as a call signal incoming tone and a message incoming tone. The audio output module 152 may include a receiver, a speaker, and a buzzer.

The alarm 153 outputs a signal for indicating the generation of an event of the mobile terminal 100. For example, a signal can be generated by the alarm 153 when receiving a call signal, receiving a message, receiving a key signal, or receiving touch input. The alarm 153 can also output signals in forms different from video signals or audio signals, such as a signal for indicating generation of an event through vibration. The video signals or the audio signals can be also output through the display module 151 or the audio output module 152.

The haptic module 154 generates various haptic effects that the user can feel. One representative example of the haptic effects is vibration. The intensity and pattern of vibration generated by the haptic module 154 can also be controlled. For example, different vibrations can be combined and output or can be sequentially output.

Further, the haptic module 154 can generate a variety of haptic effects. The haptic effects include an effect of stimulus according to arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 can transmit not only haptic effects through direct contact but also allow the user to feel haptic effects through a kinesthetic sense of the user's fingers or arms. The mobile terminal 100 may include multiple haptic modules 154.

The memory 160 can store a program for the operation of the controller 180 and temporarily store input/output data, such as phone book, messages, still images, and moving images. The memory 160 can also store data related to vibrations and sounds in various patterns, which are output when a touch input is applied to the touch screen.

Further, the memory 160 can include a flash memory, a hard disk type memory, a multimedia card micro type memory, a random access memory (RAM), a static RAM (SRAM), a read-only memory (ROM), an electrically erasable programmable ROM (EEPROM), a programmable ROM (PROM) magnetic memory, a magnetic disk, an optical disk, or a card type memory such as SD or XD memory. The mobile terminal 100 can also operate in relation to a web storage performing the storing function of the memory 160 via the Internet.

The interface 170 serves as a path to external devices connected to the mobile terminal 100. Further, the interface 170 receives data from the external devices or power and transmits the data or power to the internal components of the mobile terminal 100 or transmits data of the mobile terminal 100 to the external devices. Also, the interface 170 can include a wired/wireless headset port, an external charger port, a wired/wireless data port, a memory card port, a port for connecting a device having a user identification module, an audio I/O port, a video I/O port, or an earphone port, for example.

The interface 170 can also interface with a user identification module that is a chip that stores information for authenticating the authority to use the mobile terminal 100. For example, the user identification module includes a user identify module (UIM), a subscriber identify module (SIM) or a universal subscriber identify module (USIM).

An identification device including the user identification module can also be manufactured in the form of a smart card. Accordingly, the identification device may be connected to the mobile terminal 100 through a port of the interface 170.

The interface 170 can also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle can be used as signals for confirming whether the mobile terminal 100 is correctly set in the cradle.

The controller 180 controls the overall operations of the mobile terminal 100. For example, the controller 180 performs control and processing for voice communication, data communication and video telephony. As shown in FIG. 1(a), the controller 180 also includes a multimedia module 181 for playing multimedia. The multimedia module 181 may be included in the controller 180 as shown in FIG. 1(a) or can be separated from the controller 180.

Further, the controller 180 can perform a pattern recognition process capable of recognizing handwriting input or picture-drawing input applied to the touch screen as characters or images. In addition, the power supply 190 receives external power and internal power and provides power required for the operations of the components of the mobile terminal 100 under the control of the controller 180.

According to hardware implementation, the embodiments of the present invention can be implemented using application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electrical units for executing functions. In some cases, the embodiments of the present invention may be implemented by the controller 180.

According to software implementation, embodiments such as procedures or functions can be implemented with a separate software module executing at least one function or operation. Software codes can be implemented according to a software application written in an appropriate software language. Furthermore, the software codes can be stored in the memory 160 and executed by the controller 180.

Various embodiments of the present invention will be explained. In the specification, a touch signal or a touch operation may include both a contact touch and a proximity touch. Further, the touch signal or the touch operation may include a point touch or a stroke including a flicking operation and a dragging operation. The proximity touch will be described in detail with reference to FIG. 1(b).

The proximity sensor 141 described with reference to FIG. 1(a) will now be explained in more detail with reference to FIG. 1(b). FIG. 1(b) is a conceptual diagram used for explaining a proximity depth of the proximity sensor 141.

As shown in FIG. 1(b), when a pointer such as a user's finger approaches the touch screen, the proximity sensor 141 located inside or near the touch screen senses the approaching pointer and outputs a proximity signal. Further, the proximity sensor 141 can be constructed such that it outputs a proximity signal according to the distance between the pointer approaching the touch screen and the touch screen (referred to as “proximity depth”).

Also, the distance at which the proximity signal is output when the pointer approaches the touch screen is referred to as a detection distance. The proximity depth can be determined by using a plurality of proximity sensors 141 having different detection distances and comparing proximity signals respectively output from the proximity sensors 141.

FIG. 1(b) shows the section of the touch screen in which proximity sensors 141 capable of sensing three proximity depths are arranged. Of course, proximity sensors 141 capable of sensing less than three or more than three proximity depths can be arranged in the touch screen. Accordingly, the controller 180 can recognize the proximity touch as various input signals according to the proximity distance and proximity position of the pointer with respect to the touch screen and perform various operations according to the input signals.

Thus, as shown in FIG. 1(b), when the pointer or user's finger as in this example completely comes into contact with the touch screen (D0), the controller 180 recognizes this action as the contact touch. When the pointer is located within a distance D1 from the touch screen without contacting the touch screen, the controller 180 recognizes this action as a proximity touch of a first proximity depth.

Similarly, when the pointer is located in a range between the distance D1 and a distance D2 from the touch screen, the controller 180 recognizes this action as a proximity touch of a second proximity depth. When the pointer is located in a range between the distance D2 and a distance D3 from the touch screen, the controller 180 recognizes this action a proximity touch of a third proximity depth. Also, when the pointer is located at a distance greater than D3 from the touch screen, the controller 180 does not recognize any proximity touch.

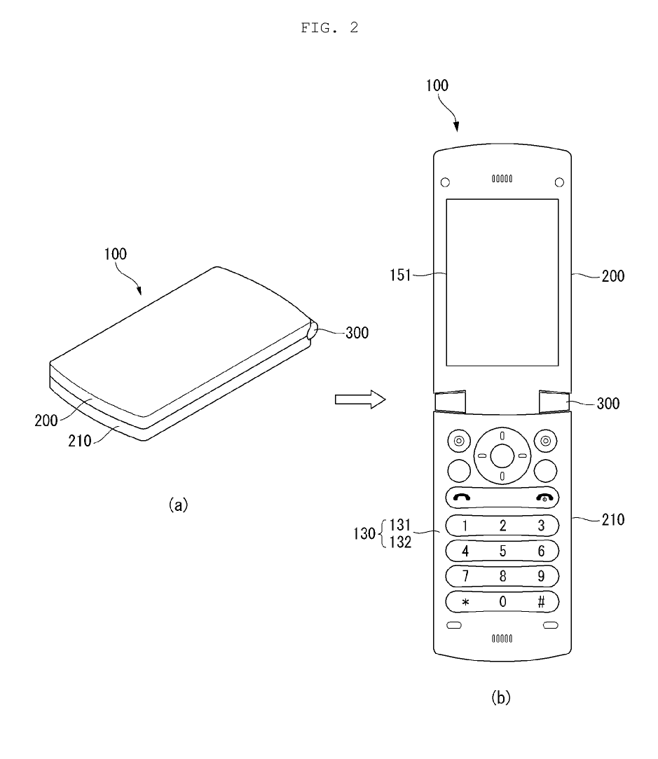

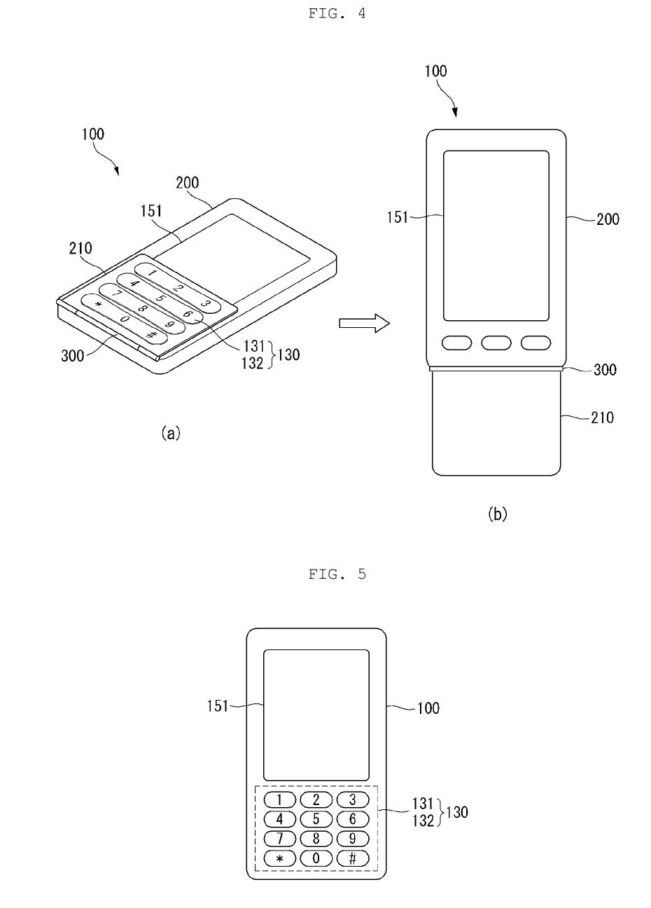

The mobile terminal 100 may have a single body or two or more bodies. For example, FIGS. 2-4 illustrate the mobile terminal 100 having a first body 200 and a second body 210 and FIG. 5 illustrates the mobile terminal 100 having a single body. When the mobile terminal 100 has two or more bodies, as shown in FIGS. 2-4, the bodies can be connected with each other in various forms.

Referring to FIGS. 2(a) and 2(b), the mobile terminal 100 may be a folder type. FIG. 2(a) illustrates that the first and second bodies 200 and 210 in a closed state and FIG. 2(b) illustrates that the first and second bodies 200 and 210 in an open state. The mobile terminal 100 may further include a connecting part 300 for rotatably connecting the first and second bodies 200 and 210 such that the mobile terminal 100 can be folded or opened via the connecting part 300.

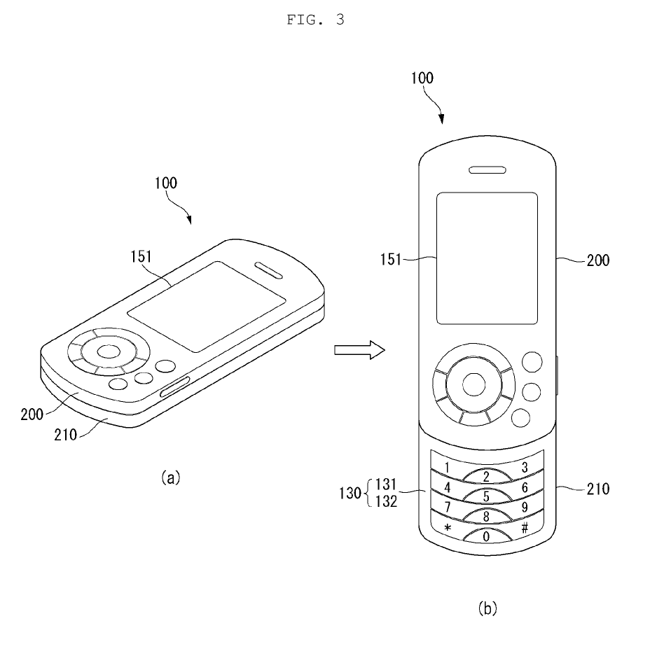

Referring to FIGS. 3(a) and 3(b), the mobile terminal 100 may be a slide type. FIG. 3(a) illustrates that the first and second bodies 200 and 210 in a closed state and FIG. 3(b) illustrates that the first and second bodies 200 and 210 in an open state. The mobile terminal 100 may further include a connecting part (not shown) for slidably connecting the first and second bodies 200 and 210 such that the first and second bodies 200 and 210 can slide against each other.

Referring to FIGS. 4(a) and 4(b), the mobile terminal 100 may be a flip type. FIG. 4(a) illustrates that the first and second bodies 200 and 210 in a closed state and FIG. 4(b) illustrates that the first and second bodies 200 and 210 in an open state. The mobile terminal 100 may further include a connecting part 300 for rotatably connecting the first and second bodies 200 and 210 with each other such that the mobile terminal 100 can be folded.

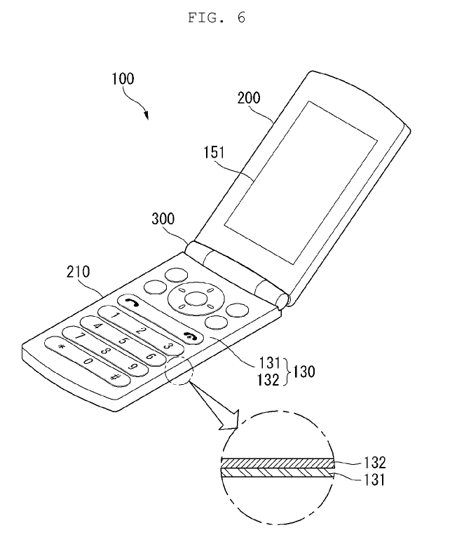

Referring to FIGS. 2(a)-6, the mobile terminal 100 includes a touch panel 131 and the key input unit 132. The touch panel 131 and the key input unit 132 may be arranged in parallel such that the touch panel 131 and the key input unit 132 overlap, as illustrated in FIG. 6.

For example, the key input unit 132 may be arranged on top of the touch panel 131. However, the present invention is not limited to this configuration and the key input unit 132 may be located under the touch panel 131.

Referring to FIG. 5, the mobile terminal 100 may be a bar type having a single body. Similar to the dual body type mobile terminal 100 of FIGS. 2(a)-4(b), the user input unit 130 of the bar type mobile terminal 100, as disclosed in FIG. 5, includes the touch panel 131 and the key input unit 132 arranged in parallel.

As described above with reference to FIGS. 2(a) through 6, the touch panel 131 and the key input unit 132 are arranged in parallel. Accordingly, the touch panel 131 and the key input unit 132 can be at least partially superimposed.

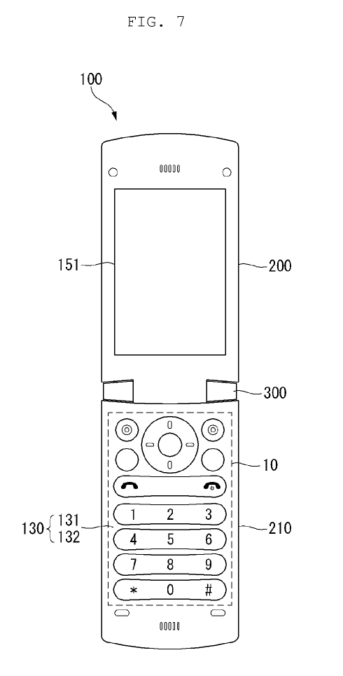

FIG. 7 illustrates a mobile terminal 100 with a touch region 10 for sensing a touch by an external object. Referring to FIG. 7, the controller 180 can receive both a touch signal transmitted from the touch panel 131 and a key signal transmitted from the key input unit 132.

The touch region 10 may vary in size or have various configurations, which will be explained later. The size of the touch region 10 may be smaller than or identical to the size of the touch panel 131.

Further referring to FIG. 7, a user can enter an input through the touch region 10 to generate a touch signal or enter an input through key areas included in the key input unit 132 corresponding to the touch region 10 to generate a key signal. For example, the user can touch the touch region 10 with a finger or push a specific key or key area included in the key input unit 132 to enter an input. In other words, the user can touch and/or push the same point on the touch region 10 and different types of signals may be generated depending on what type of input is received at the same point.

A method of receiving information through the touch panel 131 and the key input unit 132 will now be explained with reference to the attached drawings. The touch panel 131 and the key input unit 132 may be simultaneously activated or only one of them may be activated as desired depending on set up.

FIG. 8 illustrates a mobile terminal 100 including a toggle key 135 for switching between the touch panel 131 and the key input unit 132. When the user presses the toggle key 135, the controller 180 can activate the touch panel 131 and the key input unit 132 one-by-one in order.

For example, when the user presses the toggle key 135, the touch panel 131 is activated and the key input unit 132 is deactivated, and thus the user can input a touch signal through the currently set touch region 10. Here, the mobile terminal 100 recognizes touch inputs, but does not recognize any key inputs even when the user presses a key included in the inactivated key input unit 132.

When the user presses the toggle key 135 while only the touch panel 131 is activated, the touch panel 131 is deactivated and the key input unit 132 is activated. In this case, the user can input only a key signal through the key input unit 132 and no touch signal is generated by the controller 180.

When the user pushes the toggle key 135 while only the key input unit 132 is activated, both the touch panel 131 and the key input unit 132 are activated and the user can enter both touch input and key input such that both a touch signal and a key signal can be recognized by the controller 180.

The controller 180 can activate only one or both of the touch panel 131 and the key input unit 132 based on an application that has been activated in the mobile terminal 100. Activation modes of the touch panel 131 and the key input unit 132 according to applications may be set or varied by the user.

For example, the controller 180 may activate both the touch panel 131 and the key input unit 132 when a web browser is activated. Further, the controller 180 may deactivate the key input unit 132 and activate only the touch panel 131 when an image viewer for displaying or editing a photo or a still image is activated. Moreover, the controller 180 may deactivate the touch panel 131 and activate the key input unit 132 when a message application providing a function for generating a message, such as a short message, a multimedia message and e-mail, is activated.

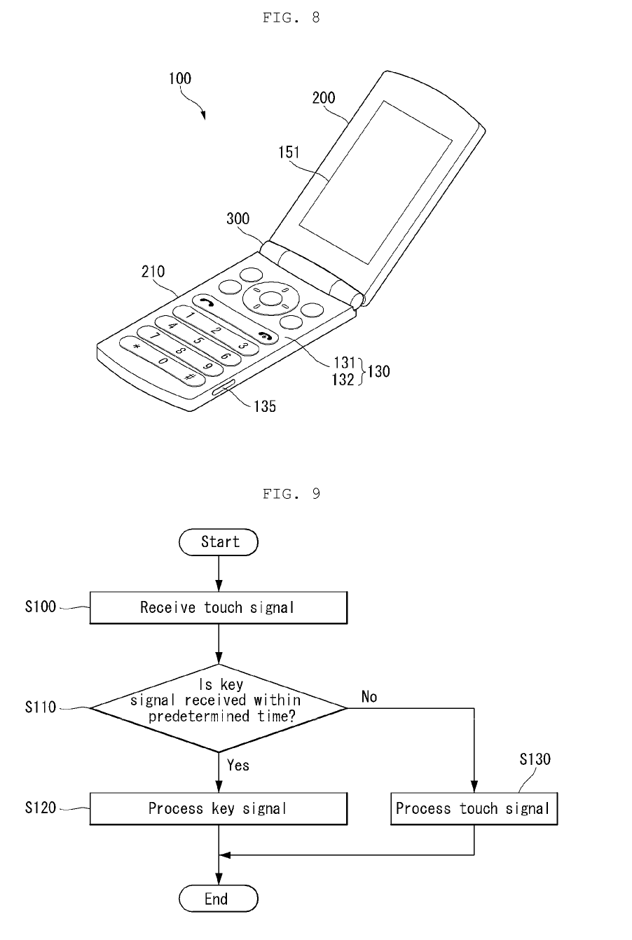

In FIG. 9, both the touch panel 131 and the key input unit 132 are activated and used. Referring to FIG. 9, the controller 180 receives a touch signal transmitted from the touch panel 131 (S100). Then, the controller 180 determines whether a key signal is transmitted from the key input unit 132 within a predetermined time after receiving the touch signal (S110). The controller 180 may determine whether to process the touch signal or the key signal according to the time when the touch signal is input, the time when the touch signal is released and the time when the key signal is input.

When the controller 180 receives the key signal from the key input unit 132 within the predetermined time after receiving the touch signal, the controller 180 processes the key signal (S120). When the controller 180 does not receive the key signal from the key input unit 132 within the predetermined time after receiving the touch signal, the controller 180 processes the received touch signal (S130).

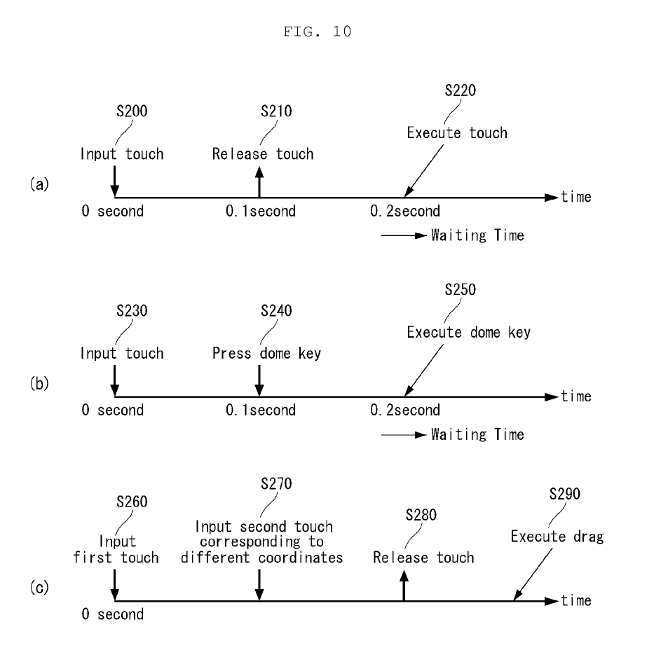

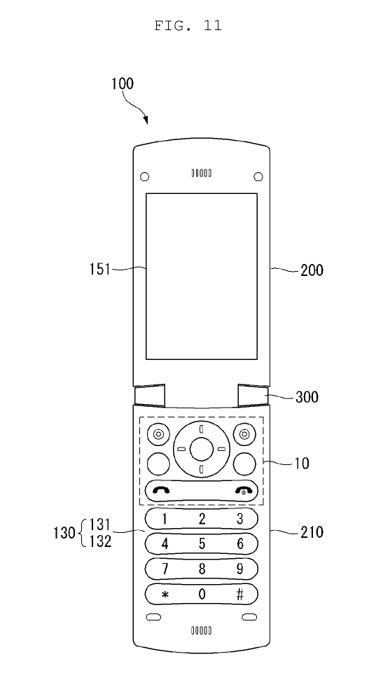

Referring to FIG. 10(a), when the controller 180 receives the touch signal from the touch panel 131 in S200 and the touch signal is released 0.1 seconds after the touch signal is received in S210, the touch signal is processed in S220 because no key signal is received within a predetermined time, for example, 0.2 seconds. Here, the time when the controller 180 processes the touch signal may correspond to the time after a lapse of a predetermined time since the touch signal was received or to the time right after the touch signal was released.

Referring to FIG. 10(b), when the controller 180 receives the touch signal from the touch panel 131 in S230 and receives the key signal from the key input unit 132 0.1 seconds after the touch signal is received in S240, the controller 180 does not process the touch signal received in S230 and processes the key signal received in S240 because the key signal was received within the predetermined time, for example, 0.2 seconds, in S250. Here, the time when the controller 180 processes the key signal may correspond to the time after a lapse of a predetermined time since the touch signal was received.

FIG. 10(c) illustrates a case where the touch signal corresponds to a stroke such as a dragging operation or a flicking operation. Referring to FIG. 10(c), the controller 180 receives a first touch signal at a first coordinate in S260 and receives a second touch signal at a second coordinate that is different from the first coordinate according to a stroke in S270. Further, the controller 180 processes the received touch signals when the controller 180 does not receive a key signal within the predetermined time in S290. Here, releasing of the touch signals, as shown in S280, may be required to process the stroke.

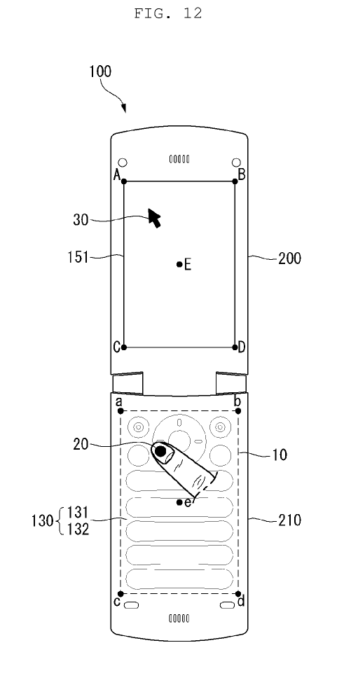

FIG. 11 illustrates setting the touch region 10 in the mobile terminal 100 according to another embodiment of the present invention. Referring to FIG. 11, the touch region 10 is a portion of the touch panel 131 and separated from the key input unit 132. However, in one aspect of the present invention, the touch region 10 may be partially superimposed on the key input unit 132.

That is, the controller 180 recognizes a touch signal applied to the touch region 10 only which corresponds to a portion of the user input unit 130. Here, the user may enter an input for generating a touch signal through the touch region 10 and an input for generating a key signal through the entire region of the user input unit 130.

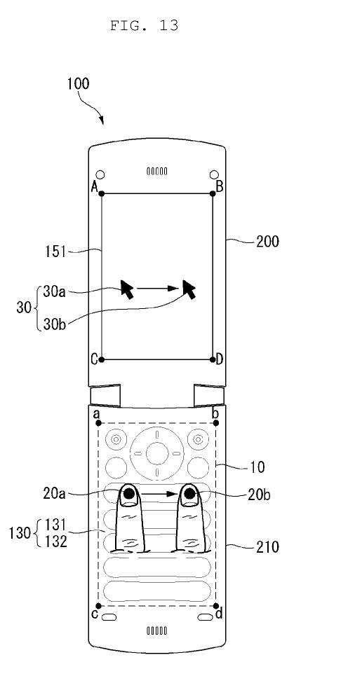

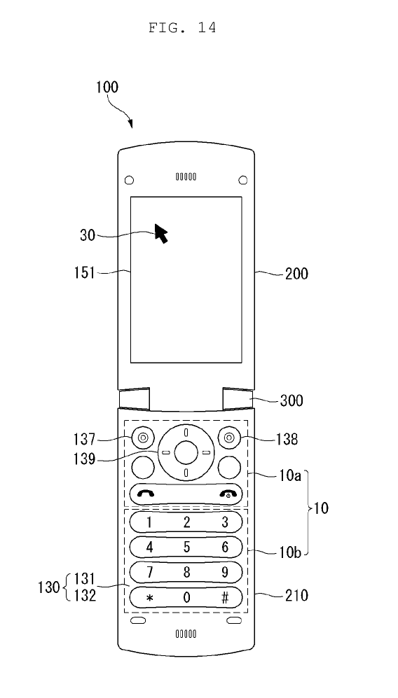

In one aspect of the present invention, the mobile terminal 100 may use various coordinate systems to control an object displayed on the display module 151 according to a touch input received through the touch region 10. FIG. 12 illustrates a case where the mobile terminal 100 uses an absolute coordinate system and FIG. 13 illustrates a case where the mobile terminal 100 uses a relative coordinate system. Examples of coordinate systems which can be used in the mobile terminal 100 will now be explained with reference to FIGS. 12 and 13.

The controller 180 displays a pointer 30 corresponding to a touch signal on the display module 151 when the controller 180 initially receives or processes the touch signal according to a preset setting. For example, the controller 180 initially receives or processes the touch signal when an image corresponding to a new application is displayed on the display module 151. Alternatively, when no information is received through the user input unit 130 for a predetermined time, the pointer 30 disappears.

Referring to FIG. 12, the controller 180 may control the pointer 30 displayed on the display module 151 by using an absolute coordinate system which matches the touch region 10 corresponding to the entire touch panel 130 or a portion of the touch panel 131 with the display module 151 one-to-one. For example, points A, B, C, D and E on the display module 151 may be respectively matched with points a, b, c, d and e on the touch region in FIG. 12. According to the absolute coordinate system, the position of a point on the touch region 10 touched by the user substantially corresponds to the relative position of the pointer 30 displayed on the display module 151.

Referring to FIG. 13, the controller 180 may control the pointer 30 displayed on the display module 151 by using a relative coordinate system which relatively matches the touch region 10 with the display module 151. For example, when point 20a touched by the user on the touch region 10 is moved or dragged to point 20b, the pointer 30 is moved by a distance corresponding to the distance between 30a and 30b.

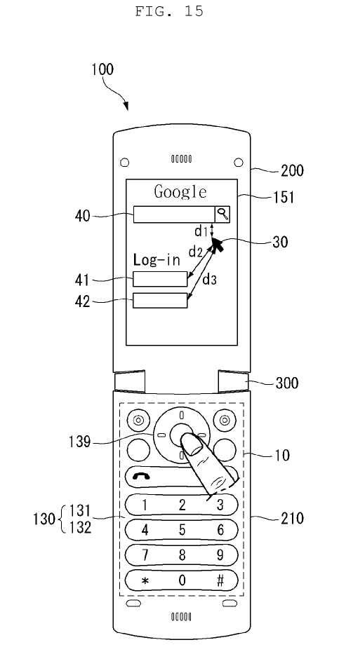

Further, the controller 180 can use both the absolute coordinate system and the relative coordinate system together. FIG. 14 illustrates a case where the mobile terminal 100 uses both the absolute coordinate system and the relative coordinate system.

Referring to FIG. 14, the relative coordinate system may be used for a first touch region 10a in the touch region 10 and the absolute coordinate system may be used for a second touch region 10b in the touch region 10. Specific functions may be allocated to keys included in the first touch region 10a for which the relative coordinate system is used. For example, functions of left/right click buttons of a pointing device such as a mouse can be respectively allocated to two dome keys 137 and 138 located at the top of the first touch region 10a.

The operation of the mobile terminal 100 when both the touch panel 131 and the key input unit 132 are used will be described in the following embodiments of the invention. The controller 180 may control the mobile communication module 112 or the wireless Internet module 113 to connect the mobile terminal 100 to the Internet. Further, the controller 180 can access a specific web site through the Internet, and then display a web page provided by the specific web site on the display module 151.

FIGS. 15-18 illustrate receiving information when the mobile terminal 100 accesses a web site according to an embodiment of the present invention. FIG. 15 illustrates an image displayed on the display module 151 when the mobile terminal 100 accesses a web site, for example “GOOGLE.”

Referring to FIG. 15, the controller 180 displays a web page provided by the “GOOGLE” site on the display module 151. The web page may include a plurality of input boxes 40, 41 and 42. The first input box 40 is a region through which a search query for web search is input, and the second and third input boxes 41 and 42 correspond to regions through which ID and a password for log-in are respectively input.

When the controller 180 receives a preset first key signal from the key input unit 132, for example a navigation key 139, the controller 180 can activate the input box closest to the current position of the pointer 30 among the input boxes 40, 41 and 42. In a prior art, the user is required to control the pointer 30 by placing it in a desired input box in order to input information to the input box. However, according to an embodiment of the present invention, the user can input information to a desired input box even if the pointer 30 is not actually placed in the input box.

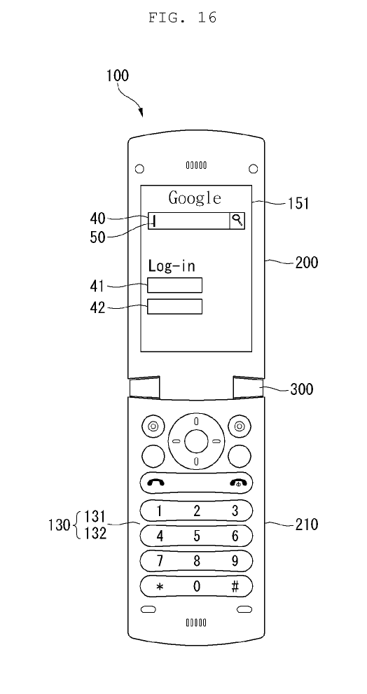

As shown in FIG. 15, the position of the pointer 30 is closest to the first input box 40 or the distance d1 between the position of the pointer 30 and the first input box 40 is shorter than the distances d2 and d3 respectively, to the second 41 and third 42 input boxes. Therefore, the first input box 40 is activated in response to the first key signal, thus placing a cursor 50 in the first input box 40 to receive input information or search query, as shown in FIG. 16.

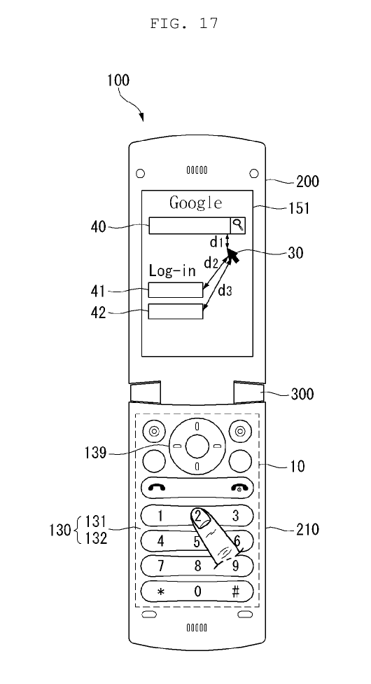

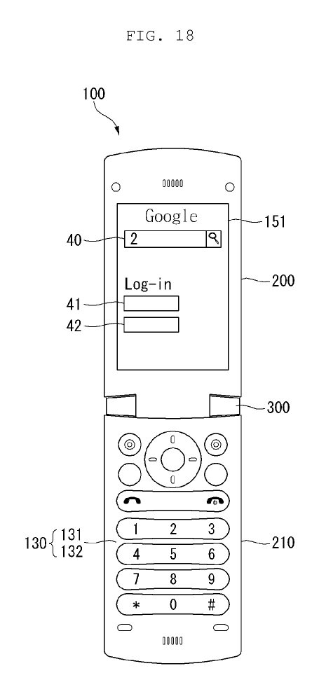

FIGS. 17 and 18 illustrate receiving information when the mobile terminal 100 accesses a web site according to another embodiment of the present invention. According to this embodiment, the input box does not need to be activated before receiving input information, and the input information can be received even when no cursor is present in the input box. In other words, when input information is received via the user input unit 130, the input information is displayed in an input box that is located closest to the position of the pointer 30.

Referring to FIG. 17, the current position of the pointer 30 is closest to the first input box 40. If the user presses a key corresponding to “2,” the controller 180 receives a key signal corresponding to “2” and displays “2” in the first input box 40 as illustrated in FIG. 18.

When the pointer 30 is moved to a region around an input box displayed in a specific web page, the controller 180 can control the haptic module 154 to generate vibration to provide feedback to the user, indicating that the pointer 30 is placed at a preset distance from the input window. Here, the controller 180 can control the pointer 30 such that the pointer 30 is not moved any more for a predetermined time after providing the feedback. For the predetermined time, the user may not be able to move the pointer 30 by using the user input unit 130.

FIG. 19 illustrates an example of using the key input unit 132 according to an embodiment of the present invention. Referring to FIG. 19, when the controller 180 receives a preset second key signal from the key input unit 132, the controller 180 may display a function key map 60 including a plurality of icons which respectively correspond to at least parts of the keys 61 and are respectively allocated to different menus on the display module 151. For example, when the user presses a specific key among the plurality of keys 61 while a specific application such as a web browser is activated or in a stand-by state, the function key map 60 may be provided.

The controller 180 may execute the menu allocated to a specific icon among the plurality of icons when receiving a key signal corresponding to the specific icon from the key input unit 132. The function key map 60 may be changed according to the currently activated application. FIG. 19 illustrates the function key map 60 provided when the web browser is activated.

For example, when the user presses a key corresponding “2” among the plurality of keys 61, the controller 180 executes a “window change” function because “Window change” is allocated to the icon corresponding to “2” in the function key map 60. Further, when the user presses a dome key corresponding to “5,” the controller 180 can add the currently accessed web site or web page to “favorite” bookmark or provide a list of web sites or web pages registered to the “favorite” bookmark because “Favorite” is allocated to the icon corresponding to “5” in the function key map 60.

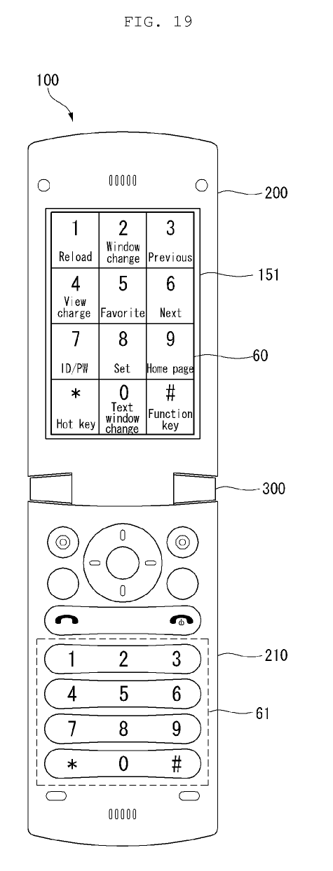

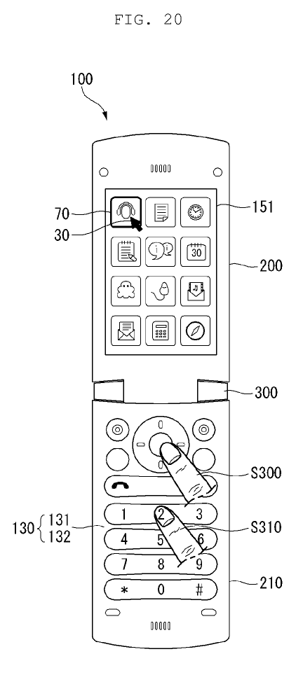

FIG. 20 illustrates an example of using the key input unit 132 according to another embodiment of the invention. Referring to FIG. 20, the controller 180 may display various objects such as icons on the display module 151. When the controller 180 receives a preset third key signal from the key input unit 132 while the pointer 30 is pointed to a specific object displayed on the display module 151, the controller 180 can execute the function allocated to the third key signal and associated with the specific object.

For example, the pointer 30 is pointing to a specific object 70 in FIG. 20. When the user presses a specific key allocated to a selection function (S300), the controller 180 can select the specific object 70 currently indicated by the pointer 30. The specific object 70 can also be selected by receiving a touch signal through the touch panel 131.

For example, assume that a specific function “capture” is allocated to a key corresponding to “2” in FIG. 20. When the user presses the key “2” (S310), the controller 180 captures an image of the specific object 70.

The controller 180 can receive a touch signal from the point corresponding to the key “2” at the moment when the user presses the key “2”. However, the controller 180 receives a key signal corresponding to the key “2” within a predetermined time according to the above-described embodiment, and thus, the received touch signal can be ignored. In this case, the pointer 30 is not moved from the point indicating the specific object 70.

As described above, various functions can be allocated to the plurality of keys included in the key input unit 132. For example, various functions such as “capture,” “store picture,” “link,” “open in new box,” “store favorite,” “copy & paste,” “view attribute,” “transmit,” “view capacity,” and “designate background image” may correspond to at least portions of the plurality of keys.

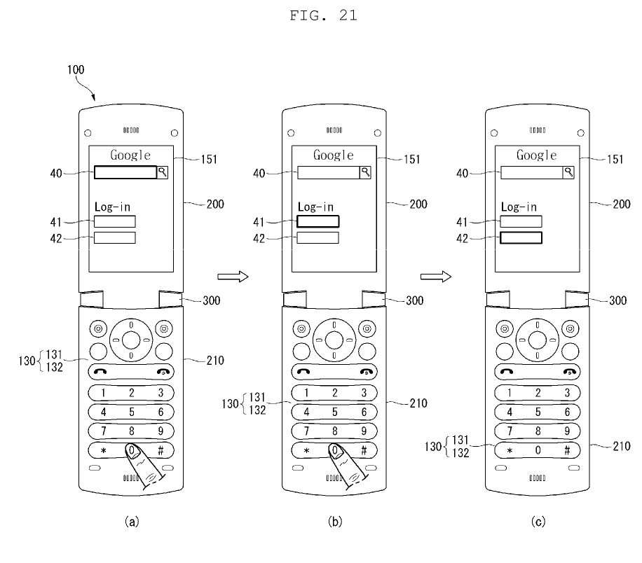

FIGS. 21(a)-21(c) illustrate an example of using the key input unit 132 according to another embodiment of the present invention. The controller 180 may move or change the objects displayed on the display module 151 whenever the controller 180 receives a specific key signal from the key input unit 132. For example, the controller 180 may switch selection of the input boxes 40, 41 and 42 whenever the user presses a key corresponding to “0.”

FIG. 21(a) illustrates that the first input box 40 is selected. In this state, selection of the first input box 40 is cancelled and the second input box 41 is selected when the user presses the key corresponding to “0.” When the user presses the key corresponding to “0” one more time, selection of the second input box 41 is cancelled and the third input box 42 is selected. Therefore, the user can easily change the current input box to the next input box by selecting a preset key or pressing the key “0.”

The above described information inputting method of a mobile terminal according to the present invention can be written as computer programs and can be implemented in digital computers that execute the programs using a computer readable recording medium. The information inputting method of a mobile terminal according to various embodiments of the present invention can be executed through software. The software can include code segments that perform required tasks. Programs or code segments can also be stored in a processor readable medium and transmitted.

The computer readable recording medium includes all types of recording devices storing data readable by computer systems. Examples of the computer readable recording medium include ROM, RAM, CD-ROM, DVD±ROM, DVD-RAM, magnetic tapes, floppy disks, hard disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A mobile terminal comprising:
a touch panel configured to receive a first input;
a key input unit at least partially overlapping the touch panel and configured to receive a second input; and
a controller configured to selectively process a first signal transmitted from the touch panel in response to the first input and a second signal transmitted from the key input unit in response to the second input,
wherein the controller is further configured to:
process the first signal as a touch input upon determining absence of the second signal within a predetermined period of time after receiving the first input; and
process the second signal as a key input upon determining presence of the second signal within the predetermined period of time after receiving the first input.

2. The mobile terminal of claim 1, wherein the second input comprises pressing the key input unit for at least a preset distance.

3. The mobile terminal of claim 1, wherein the key input unit is located on top of the touch panel.

4. The mobile terminal of claim 1, further comprising a user input unit configured to activate or deactivate at least the touch panel or the key input unit such that the first signal is not generated when the touch panel is deactivated and the second signal is not generated when the key input unit is deactivated.

5. The mobile terminal of claim 1, further comprising a display unit configured to display a plurality of information input areas, wherein the controller is further configured to display a pointer on the display unit in response to a third input and activate one of the plurality of information input areas in response to a fourth input to receive information through the activated one of the plurality of information input areas, wherein the activated one of the plurality of information input areas is located closest to the pointer at the time when the fourth input is received.

6. The mobile terminal of claim 5, wherein activating the one of the plurality of information input areas comprises displaying a cursor in the one of the plurality of information input areas.

7. The mobile terminal of claim 5, wherein the fourth input is received via one of a plurality of keys of the key input unit or one of a plurality of touch points on the touch panel and activating the one of the plurality of information input areas comprises displaying information corresponding to the fourth input in the one of the plurality of information input areas.

8. The mobile terminal of claim 7, wherein the one of the plurality of information input areas is activated only when the pointer is within a predetermined distance from the one of the plurality of information input areas.

9. The mobile terminal of claim 8, wherein the controller is further configured to notify a user that the one of the plurality of information input areas is ready to receive the information when the pointer is within the predetermined distance.

10. A method of receiving an input in a mobile terminal having a user input unit comprising a key input unit and a touch panel, the method comprising:
selectively receiving a first input or a second input via the user input unit;
generating a first signal in response to the first input or generating a second signal in response to the second input;
processing the first signal as a touch input upon determining absence of the second input within a predetermined period of time after receiving the first input; and
processing the second signal as a key input upon determining presence of the second input within the predetermined period of time after receiving the first input,
wherein the key input unit at least partially overlaps the touch panel.

11. The method of claim 11, wherein the second input comprises pressing the input unit for at least a preset distance.

12. The method of claim 11, further comprising activating or deactivating at least the touch panel or the key input unit such that the first signal is not generated when the touch panel is deactivated and the second signal is not generated when the key input unit is deactivated.

13. The method of claim 11, further comprising:
displaying a plurality of information input areas on a display unit of the mobile terminal;
displaying a pointer on the display unit in response to a third input; and
activating one of the plurality of information input areas in response to a fourth input to receive information through the activated one of the plurality of information input areas,
wherein the activated one of the plurality of information input areas is located closest to the pointer at the time when the fourth input is received.

14. The method of claim 13, further comprising displaying a cursor in the activated one of the plurality of information input areas.

15. The method of claim 13, wherein the fourth input is received via one of a plurality of keys of the key input unit or one of a plurality of touch points on the touch panel and further comprising displaying information corresponding to the fourth input in the activated one of the plurality of information input area.

16. The method of claim 13, wherein the one of the plurality of information input areas is activated only when the pointer is within a predetermined distance from the one of the plurality of information input areas.

17. The method of claim 16, further comprising notifying a user that the one of the plurality of information input areas is ready to receive the information when the pointer is within the predetermined distance.

18. A method of receiving information in a mobile terminal, the method comprising:
receiving an input via an input unit of the mobile terminal, wherein the input is for selecting one of a plurality of areas displayed on a display of the mobile terminal for receiving the information;
determining distances between a pointer and the plurality of areas displayed on the display in response to the input;
selecting one of the plurality of areas which has a shortest distance from the pointer as an area for receiving the information,
wherein the input unit comprises a key input unit at least partially overlapping a touch panel and the input is received via one of a plurality of keys of the key input unit or one of a plurality of touch points on the touch panel.

19. The method of claim 18, further comprising:
notifying that the one of the plurality of areas is ready to receive the information upon determining that the one of the plurality of areas is located within a predetermined distance from the pointer.

20. The method of claim 19, further comprising:
identifying the one of the plurality of areas visually to receive the information.
